(19) United States
(12) Patent Application Publication
(10) Pub. No.: US 2025/0300990 A1
(43) Pub. Date: Sep. 25, 2025

(54) AUTHORITY MANAGEMENT DEVICE

(71) Applicant: SEIKO EPSON CORPORATION, Tokyo (JP)

(72) Inventor: Takayuki SHIMIZU, SHIOJIRI-SHI (JP)

(21) Appl. No.: 19/081,397

(22) Filed: Mar. 17, 2025

(30) Foreign Application Priority Data
Mar. 21, 2024 (JP) 2024-044606

(51) Int. Cl. H04L 9/40

(52) U.S. Cl. CPC H04L 63/104

(57) ABSTRACT

An authority management device includes a management unit and a controller. The management unit manages, using a management table, in linkage with identification information for identifying a group to which a user who can access management target equipment, belongs, authority information representing one or a plurality of kinds of authority initially set for the group and representing authority invalidated after the initial setting. The controller executes acquiring a change request for the authority information and changing the authority information in response to the acquired change request.

The present application is based on, and claims priority from JP Application Serial Number 2024-044606, filed Mar. 21, 2024, the disclosure of which is hereby incorporated by reference herein in its entirety.

### BACKGROUND

### 1. Technical Field

The present disclosure relates to an authority management device.

### 2. Related Art

JP-A-2010-191972 discloses a system that manages a plurality of projectors using a computer network. JP-A-2010-191972 discloses that, in implementation of a multiplex management service, a user who monitors a projector is set for each building by allocating user authority for each server and that a network administrator limits an access right of a selected user to one or a plurality of specific servers. In the system disclosed in JP-A-2010-191972, users of the system are classified into three layers: a user (the network administrator explained above) who allocates the user authority to the other users; a user to whom the user authority is allocated by the network administrator; and a general user who uses the projector.

JP-A-2010-191972 is an example of the related art.

The access right concerning the projector is sometimes set not only for an individual user but also in an organization unit such as a department or a section in a company or the company. For example, when an organization B owning the projector consigns an operation of a management device to an organization A different from the organization B, in some case, a group such as the organization B is set as a unit and the access right is granted to each group.

However, when the access right in a group unit is managed, problems described below can occur. When the organization B owning the projector consigns the operation of the management device to the organization A different from the organization B, some contract is exchanged between the organization A that operates the management device and the organization B owning the projector. When a contract period has come or when some contract violation has occurred and a contract negotiation is required again during the contract period, the organization A needs to suspend the access right of the organization B. As a method of suspending the access right of the organization B, it is conceivable to delete the access right of the organization B. However, when the contract has been concluded again after the access right of the organization B was deleted, it is necessary to restore the access right of the organization B according to contract content. In this restoration operation, a large work load is imposed on a person in charge of the organization A that operates the management device, for example, the person in charge needs to carefully check the contract content with the organization B.

### SUMMARY

According to an aspect of the present disclosure, there is provided an authority management device including: a management unit; and a controller, in which the management unit manages, in linkage with first identification information for identifying a first group to which a user who can access a projector belongs, first authority information representing one or a plurality of kinds of authority initially set for the first group and representing authority invalidated after the initial setting, and the controller executes acquiring a change request for the first authority information and changing the first authority information in response to the change request.

### BRIEF DESCRIPTION OF THE DRAWINGS

FIG. 1 is a diagram illustrating a configuration example of an information system including an authority management device according to an embodiment of the present disclosure.

FIG. 2 is a diagram illustrating a configuration example of the authority management device.

FIG. 3 is a diagram illustrating an example of a management table.

FIG. 4 is a flowchart illustrating a flow of processing in an authority management method executed by a processing device according to a program.

FIG. 5 is a diagram illustrating an example of a management screen.

FIG. 6 is a diagram illustrating an example of the management table after change.

FIG. 7 is a diagram illustrating a configuration example of an authority management device according to a second embodiment of the present disclosure.

FIG. 8 is a diagram illustrating an example of a management table.

FIG. 9 is a diagram illustrating an example of the management table after change.

FIG. 10 is a diagram illustrating a configuration example of an authority management device according to a third embodiment of the present disclosure.

FIG. 11 is a diagram illustrating an example of a management table.

FIG. 12 is a diagram illustrating an example of the management table after change.

### DESCRIPTION OF EMBODIMENTS

Various technically preferable limitations are added to embodiments explained below. However, embodiments of the present disclosure are not limited to the embodiments explained below.

### 1. FIRST EMBODIMENT

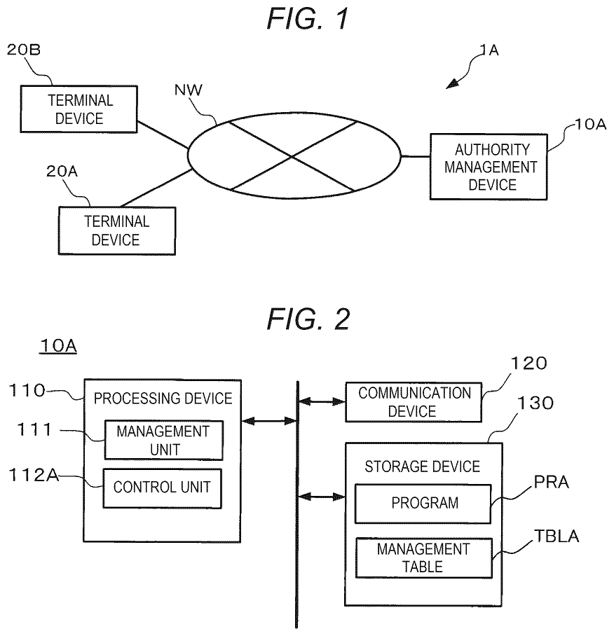

FIG. 1 is a diagram illustrating a configuration example of an information system 1A including an authority management device 10A according to an embodiment of the present disclosure. As illustrated in FIG. 1, the information system 1A includes the authority management device 10A, a terminal device 20A, and a terminal device 20B. Each of the authority management device 10A, the terminal device 20A, and the terminal device 20B is connected to a network NW such as the Internet. The authority management device 10A communicates with each of the terminal device 20A and the terminal device 20B via the network NW.

The terminal device 20B is a computer device used by a person in charge of a system in an organization B owning electronic equipment that is an authority management target (hereinafter, management target equipment). The management target equipment in the present embodiment is a projector. In FIG. 1, illustration of the management target equipment is omitted. The terminal device 20A is a computer device used by a person in charge of a system in an organization A different from the organization B. The organization A in the present embodiment is an organization to which operation management for the management target equipment is consigned from the organization B by a contract. In the present embodiment, an organization such as the organization A and the organization B (hereinafter also referred to as group) is set as a unit and authority for the management target equipment is set for each group. The authority management device 10A is a computer device for managing the authority set for the management target equipment for each group and is operated by the organization A.

As explained above, when a contract period of a contract exchanged between the organization A and the organization B has come or when a contract negotiation is required again because the organization B violates a contract condition, the organization A needs to invalidate the authority of the organization B. When the authority of the organization B is restored after the authority of the organization B is invalidated, in some case, work for, for example, carefully checking contract content in order to specify the authority that should be restored is required and a large work load is imposed on the person in charge of the system of the organization A. The authority management device 10A is a device for enabling authority set for the management target equipment for each group while reducing a load imposed on the person in charge of the system of the organization A. The authority management device 10A is mainly explained below.

FIG. 2 is a diagram illustrating a configuration example of the authority management device 10A. As illustrated in FIG. 2, the authority management device 10A includes a processing device 110, a communication device 120, and a storage device 130.

The processing device 110 is one or more processors. The processing device 110 is, for example, a central processing unit (CPU). The processing device 110 operates according to a program PRA stored in the storage device 130 to thereby function as a control center of the authority management device 10A. The communication device 120 is a device that performs wireless communication or wired communication with other devices and includes, for example, an interface circuit. Specific examples of other devices communicating with the communication device 120 include a terminal device 20A and a terminal device 20B.

The storage device 130 is a recording medium readable by the processing device 110. The storage device 130 includes, for example, a nonvolatile memory and a volatile memory. The nonvolatile memory is, for example, a read only memory (ROM), an erasable programmable read only memory (EPROM), or an electrically erasable programmable read only memory (EEPROM). The volatile memory is, for example, a random access memory (RAM). Various programs and a management table TBLA are stored in the nonvolatile memory of the storage device 130.

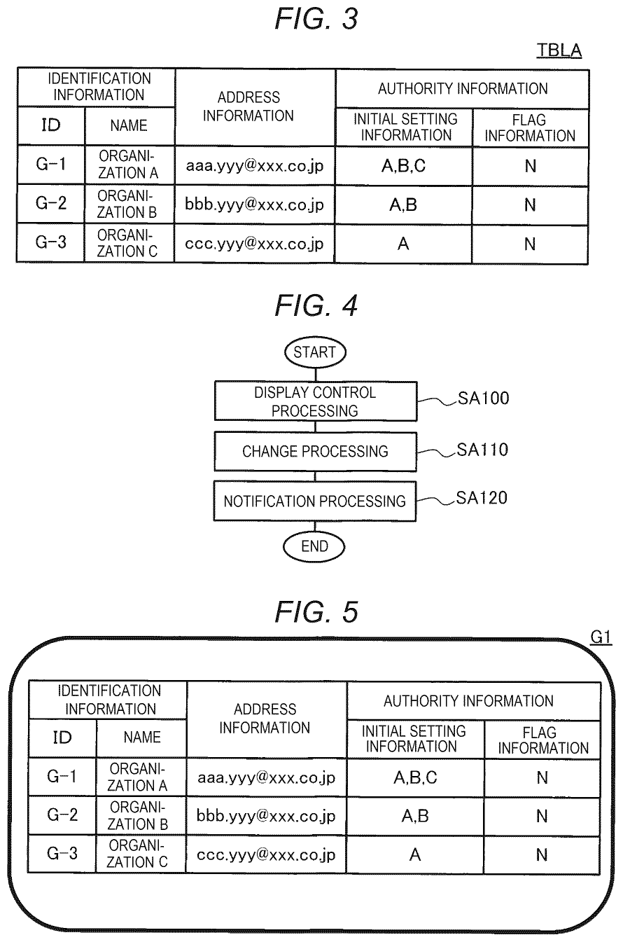

FIG. 3 is a diagram illustrating an example of the management table TBLA. As illustrated in FIG. 3, the management table TBLA stores, in linkage with identification information for uniquely identifying an organization for which authority is set, address information and authority information indicating the authority set for the organization. The identification information in the present embodiment includes an ID given to the organization and a character string representing a name of the organization. However, the identification information may include one of a character string representing the ID and the character string representing the name. The address information stores a mail address of a person in charge of a system in the organization indicated by the identification information stored in the management table TBLA in association with the address information.

The authority information includes initial setting information indicating authority initially set for the organization indicated by the identification information stored in the management table TBLA in linkage with the authority information and flag information representing validity or invalidity of the authority indicated by the initial setting information. One or a plurality of characters “A”, “B”, and “C” are set in the initial setting information. The character “A” in the initial setting information indicates that authority “A” is initially set. The character “B” in the initial setting information indicates that authority “B” different from the authority “A” is initially set. The character “C” in the initial setting information indicates that authority “C” different from the authority “A” and also different from the authority “B” is initially set. For example, in the example illustrated in FIG. 3, since the initial setting information corresponding to the organization A is “A, B, and C”, the authority “A”, the authority “B”, and the authority “C” are set for the organization A. In the example illustrated in FIG. 3, since the initial setting information corresponding to the organization B is “A and B”, the authority “A” and the authority “B” are set for the organization B. In the flag information, a character “Y” or a character “N” is set. The character “Y” in the flag information indicates that all kinds of the authority indicated by the initial setting information corresponding to the flag information are invalidated. The character “N” in the flag information indicates that all kinds of the authority indicated by the initial setting information corresponding to the flag information are valid. At an initial setting point in time of the authority, “N” is set in the flag information.

Examples of the various programs stored in the nonvolatile memory include a kernel program and the program PRA. In FIG. 2, illustration of the kernel program is omitted. The processing device 110 reads the kernel program from the nonvolatile memory to the volatile memory at the opportunity when the authority management device 10A is turned on and starts executing the read kernel program. The processing device 110 operating according to the kernel program starts execution of an other program at the opportunity when an execution start of the other program is instructed. For example, when an execution start of the program PRA is instructed, the processing device 110 reads the program PRA from the nonvolatile memory to the volatile memory and starts executing the program PRA read to the volatile memory.

The processing device 110 operating according to the program PRA functions as a management unit 111 and a controller 112A illustrated in FIG. 2. That is, each of the management unit 111 and the controller 112A illustrated in FIG. 2 is a software module implemented by causing the processing device 110 to operate according to the program PRA. A role of each of the management unit 111 and the controller 112A illustrated in FIG. 2 is as explained below.

The management unit 111 uses the management table TBLA to manage authority information in linkage with identification information and manage propriety of access to the management target equipment. When a change request for requesting a change of authority stored in the management table TBLA is received by the communication device 120, the controller 112A acquires the change request from the communication device 120 and changes storage content of the management table TBLA in response to the change request.

The change request in the present embodiment is a signal for requesting to collectively invalidate authority granted to a certain organization or to collectively restore invalidated authority. The change request includes identification information of the organization in which the authority is collectively changed. When acquiring a change request instructing invalidation, the controller 112A updates the flag information stored in the management table TBLA in linkage with the same identification information as identification information included in the change request from “N” to “Y” to thereby collectively invalidate authority set for the organization. On the other hand, when acquiring a change request for instructing restoration, the controller 112A updates the flag information stored in the management table TBLA in linkage with the same identification information as the identification information included in the change request from “Y” to “N” to thereby collectively restore invalidated authority.

When the controller 112A has changed the authority information in response to the change request, the controller 112A sets, as a transmission destination address, a mail address indicated by address information stored in the management table TBLA in linkage with the same identification information as the identification information included in the change request and transmits an e-mail describing the change of the authority in a body and a title to thereby notify that the authority has been changed.

The configuration of the authority management device 10A is as explained above.

The processing device 110 operating according to the program PRA executes an authority management method markedly indicating characteristics of the present disclosure. FIG. 4 is a diagram illustrating a flow of processing included in the authority management method. As illustrated in FIG. 4, the authority management method in the present embodiment includes processing such as display control processing SA100, change processing SA110, and notification processing SA120. In the following explanation, content of processing executed by the authority management device 10A in the authority management method of the present disclosure is explained taking, as an example, a case in which authority initially set for the organization B is collectively invalidated under a situation in which the storage content of the management table TBLA is the state illustrated in FIG. 3. The organization B in the present embodiment is an example of a first group in the present disclosure. Identification information indicating the organization B is an example of first identification information in the present disclosure and authority information indicating authority of the organization B is an example of the first authority information in the present disclosure.

When a system administrator in the organization A desires to change authority set for another organization, the system administrator logs in to the authority management device 10A using the terminal device 20A. When detecting login of a user of the terminal device 20A, the processing device 110 executes the display control processing SA100. In the display control processing SA100, the processing device 110 refers to the storage content of the management table TBLA and generates screen data representing a management screen G1 illustrated in FIG. 5. Then, the processing device 110 transmits the generated screen data to the terminal device 20A to thereby cause the terminal device 20A to display the management screen G1.

As illustrated in FIG. 5, the management screen G1 is a screen for displaying identification information, address information, and authority information of organizations in a list form for each of the organizations. By referring to the management screen G1 displayed on the terminal device 20A, the system administrator in the organization A can grasp authority initially set for each of the organizations and whether the authority is valid. The system administrator in the organization A can instruct to change the authority of the organization indicated by the identification information by selecting any identification information displayed on the management screen G1 and performing operation for instructing to collectively invalidate the authority or restoring invalidated authority. When the operation explained above is performed on the terminal device 20A, the terminal device 20A generates a change request according to operation of the user and transmits the generated change request to the authority management device 10A. For example, it is assumed that the organization B has been selected by the terminal device 20A and operation for instructing to collectively invalidate authority of the organization B has been performed. In this case, the terminal device 20A transmits, to the authority management device 10A, a change request including identification information of the organization B and indicating that authority set in the organization B is collectively invalidated.

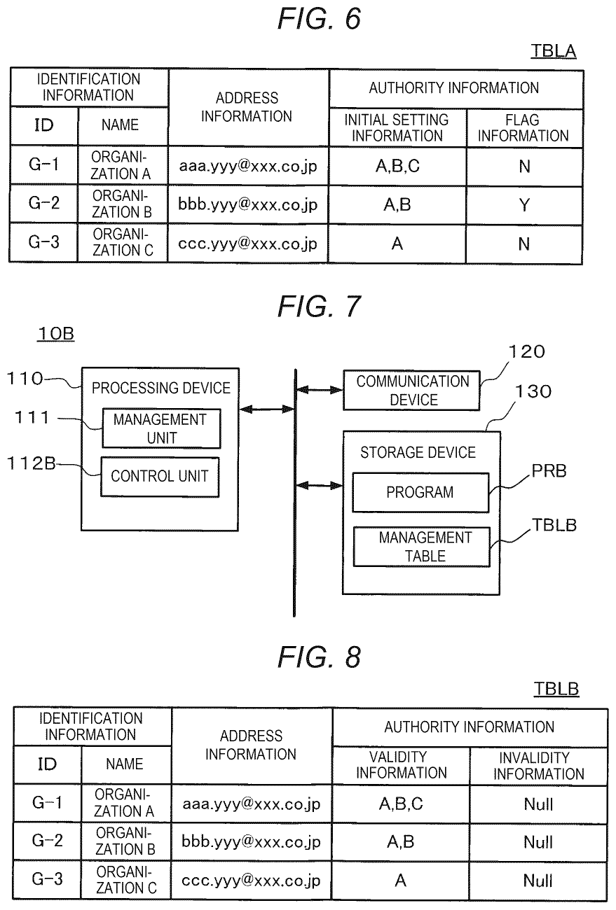

The change processing SA110 executed following the display control processing SA100 is processing executed at the opportunity of reception of the change request by the communication device 120. In the change processing SA110, the processing device 110 functions as the controller 112A. That is, in the change processing SA110, the processing device 110 changes, based on the change request acquired from the communication device 120, a value corresponding to identification information stored in the management table TBLA. When the change request acquired from the communication device 120 indicates that the authority set in the organization B is collectively invalidated, the processing device 110 updates the flag information stored in the management table TBLA in association with the identification information indicating the organization B from “N” to “Y”. According to the update, the storage content of the management table TBLA changes to a state illustrated in FIG. 6 and all of the authority “A” and the authority “B” initially set for the organization B are invalidated.

In the notification processing SA120 following the change processing SA110, the processing device 110 functions as the controller 112A. In the notification processing SA120, the processing device 110 sets, as a transmission destination address, a mail address indicated by address information stored in the management table TBLA in linkage with the same identification information as identification information included in the change request and transmits an e-mail describing the change of the authority in a body and a title to thereby notify that the authority has been changed. As explained above, an organization indicated by the identification information included in the change request acquired by the processing device 110 in this operation example is the organization B. For this reason, the processing device 110 reads address information stored in the management table TBLA in association with the identification information of the organization B, sets, as a transmission destination address, a mail address indicated by the address information, and transmits an e-mail indicating that the authority has been changed. By receiving and viewing the e-mail using the terminal device 20B, a person in charge of a system of the organization B can grasp that the authority set for the organization to which the person in charge of the system belongs has been changed.

According to the present embodiment, by selecting any identification information while referring to the management screen G1 displayed on the terminal device 20A and performing operation for instructing to collectively invalidate authority or restoring invalidated authority, the system administrator in the organization A can change authority of an organization indicated by the identification information. For this reason, when authority is restored for an organization in which the authority is invalidated, it is unnecessary to check content of a contract exchanged between the organization and an organization to which the person in charge of the system belongs. A work load on the person in charge of the system is reduced. In other words, according to the present embodiment, when authority is invalidated, it is unnecessary to record setting content before the invalidation in preparation for restoration and processing for invalidation of authority for which restoration is planned to a certain degree is facilitated. As explained above, with the authority management device 10A in the present embodiment, it is possible to change authority set for the management target equipment for each group while reducing a load imposed on the person in charge of the system of the organization A. According to the present embodiment, when access to the management target equipment has occurred and flag information stored in the management table TBLA in association with identification information of an organization at a source of the access is “Y”, the processing device 110 can reject the access without checking consistency between access content and authority set for the access source. Therefore, a processing load concerning management of the access is reduced.

### 2. OTHER EMBODIMENTS

### 2-1: Second Embodiment

FIG. 7 is a diagram illustrating a configuration example of an authority management device 10B according to a second embodiment of the present disclosure. In FIG. 7, the same elements as the elements in FIG. 2 are denoted by the same reference numerals and signs as the reference numerals and signs in FIG. 2. As it is evident when FIG. 7 and FIG. 2 are compared, a hardware configuration of the authority management device 10B is the same as the hardware configuration of the authority management device 10A. A configuration of the authority management device 10B is different from the configuration of the authority management device 10A in that a management table TBLB is stored in the storage device 130 instead of the management table TBLA and that a program PRB is stored in the storage device 130 instead of the program PRA. In the following explanation, the management table TBLB and the program PRB, which are the differences from the authority management device 10A, are mainly explained.

FIG. 8 is a diagram illustrating an example of the management table TBLB. As it is evident when FIG. 8 and FIG. 3 are compared, the management table TBLB is the same as the management table TBLA in that address information and authority information are stored in linkage with identification information. As illustrated in FIG. 8, the present embodiment is different from the first embodiment in that authority information includes validity information indicating valid authority in initially set authority and invalidity information indicating an authority to be invalidated in the initially set authority. At a stage of initial setting of authority, Null (0x00) is set in the invalidity information.

The present embodiment is different from the first embodiment in that the user of the terminal device 20A can designate, on the management screen G1, an organization that is a change target of authority, a change mode of authority such as invalidation or restoration, and change target authority. In the present embodiment, a change request transmitted from the terminal device 20A to the authority management device 10B includes identification information of an organization that is a change target of authority, information indicating a change mode of authority, and information indicating change target authority. That is, the present embodiment is different from the first embodiment in that, when a plurality of rights are set in an organization, invalidation and restoration are possible in a unit of authority.

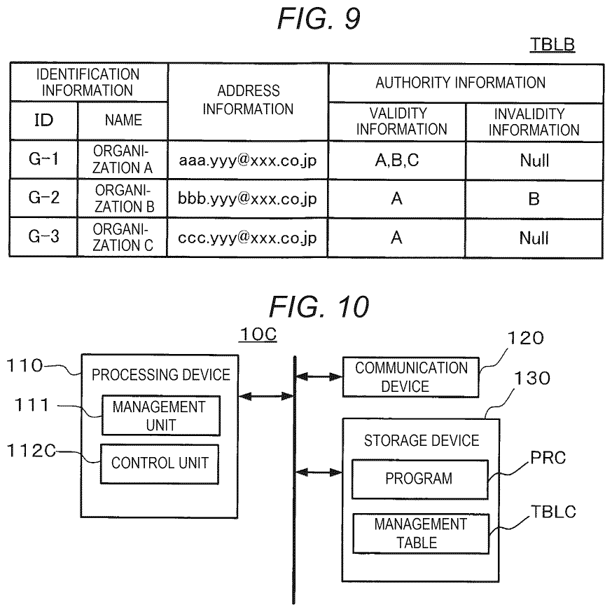

The processing device 110 operating according to the program PRB functions as the management unit 111 and a controller 112B. The management unit 111 according to the present embodiment use the management table TBLB to manage authority information in linkage with identification information and manage propriety of access to the management target equipment. The controller 112B updates the management table TBLB in response to a change request acquired from the communication device 120. More specifically, when the acquired change request includes information indicating invalidation of authority, the controller 112B deletes, from the validity information, a character indicating authority designated as a change target by information included in the change request among characters representing authority registered in the validity information in association with the same identification information as identification information included in the change request and invalidates only the authority by moving the character to the invalidity information. For example, when the organization that is the change target of the authority is the organization B and the invalidation target authority is the authority “B”, the controller 112B updates the storage content of the management table TBLB as illustrated in FIG. 9. The controller 112B is the same as the controller 112A in the first embodiment in that, when authority is changed, the controller 112B notifies, with an e-mail, the change of the authority to a system administrator of an organization for which the authority has been changed. The processing device 110 operating according to the program PRB is the same as the processing device 110 in the first embodiment in that the processing device 110 executes the authority management method explained above but is different from the processing device 110 in the first embodiment in that the processing device 110 functions as the controller 112B in the change processing SA110 and the notification processing SA120.

According to the present embodiment, when the system administrator in the organization A restores authority once invalidated, the system administrator only has to perform operation of moving a character indicating the relevant authority from the invalidity information to the validity information. Therefore, according to the present embodiment as well, since authority that was valid before the authority is invalidated can be grasped for each customer, a work load of a person in charge of a system is reduced compared with when deleted authority is registered anew. According to the present embodiment, when a plurality of kinds of authority are set for an organization, there is an effect that it is possible to perform invalidation and restoration in a unit of a right.

### 2-2: Third Embodiment

FIG. 10 is a diagram illustrating a configuration example of an authority management device 10C according to a third embodiment of the present disclosure. In FIG. 10, the same elements as the elements in FIG. 2 are denoted by the same reference numerals and signs as those in FIG. 2. As it is evident when FIG. 10 and FIG. 2 are compared, a hardware configuration of the authority management device 10C is the same as the hardware configuration of the authority management device 10A. A configuration of the authority management device 10C is different from the configuration of the authority management device 10A in that a management table TBLC is stored in the storage device 130 instead of the management table TBLA and that a program PRC is stored in the storage device 130 instead of the program PRA. In the following explanation, the management table TBLC and the program PRC, which the differences from the authority management device 10A, are mainly explained.

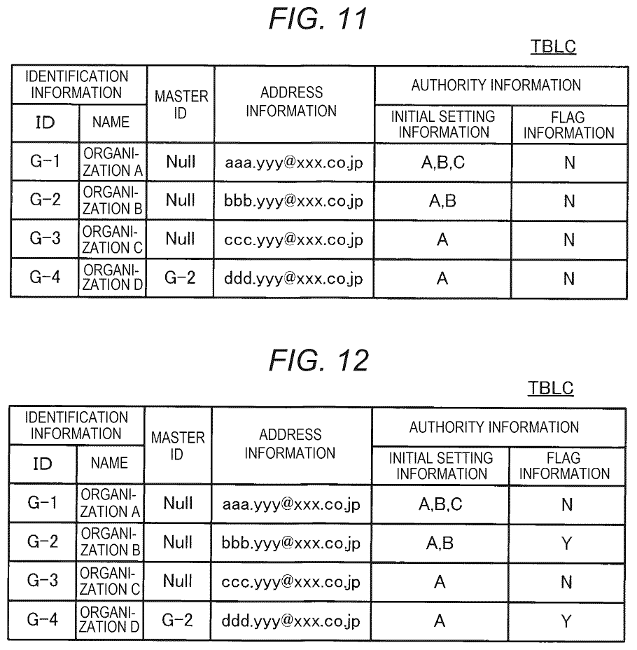

FIG. 11 is a diagram illustrating an example of the management table TBLC. As it is evident when FIG. 11 and FIG. 3 are compared, the management table TBLC is the same as the management table TBLA in that address information and authority information are stored in association with identification information but is different from the management table TBLA in that a master ID is further stored in association with the identification information. An ID of a higher level organization (hereinafter, master group) of an organization indicated by identification information associated with the master ID is stored in the master ID. An organization in which an ID of another organization is set to the master ID is referred to as a slave group. Null is stored in a master ID of an organization having no master group. In the example illustrated in FIG. 11, an organization D is a slave group of the organization B (in other words, a master group of the organization D is the organization B). The organization D in the present embodiment is an example of a second group in the present disclosure. Identification information indicating the organization D is an example of second identification information in the present disclosure and authority information indicating authority of the organization D is an example of second authority information in the present disclosure. In the management table TBLC in the present embodiment, the master group and the slave group are linked by the master ID.

The present embodiment is the same as the first embodiment in that the user of the terminal device 20A can designate, on the management screen G1, an organization that is a change target of authority and a change mode of authority such as invalidation or restoration. A change request transmitted from the terminal device 20A to the authority management device 10C includes identification information of the organization that is the change target of the authority and information indicating the change mode of the authority. The present embodiment is the same as the first embodiment in that all kinds of authority of an organization designated by the request are collectively changed in the change mode designated by the change request. In addition, the present embodiment is different from the first embodiment in that, when authority is set for another organization (that is, slave group) in which the organization designated by the change request is set as a master group, the authority of the slave group is collectively changed according to the change request. A relationship between the master group and the slave group is not limited to a relationship between a certain organization and a department of the organization and may be a relationship between a parent company and a subsidiary or a relationship between a distributor and an agency. When the relationship between the master group and the slave group is the relationship between the distributor and the agency, authority set for the slave group (the agency) includes distributor authority set for the agency by the distributor.

The processing device 110 operating according to the program PRC functions as the management unit 111 and a controller 112C. The management unit 111 in the present embodiment manages authority information in linkage with identification information using the management table TBLC and manages propriety of access to the management target equipment. The controller 112C is the same as the controller 112A in the first embodiment in that, when acquiring a change request instructing invalidation, the controller 112C updates flag information stored in the management table TBLC in association with the same identification information as identification information included in the change request from “N” to “Y” to thereby collectively invalidate authority set for the organization. When authority is set for a slave group having, as the master group, the organization for which the invalidation of the authority is instructed by the change request, the controller 112C also collectively invalidates the authority of the slave group. For example, when the identification information included in the change request indicates the “organization B”, the controller 112C collectively invalidates authority of the organization D in which an ID of the organization B is set in a master ID. As a result, storage content of the management table TBLC is changed as illustrated in FIG. 12. The controller 112C is the same as the controller 112A in the first embodiment in that, when authority is changed, the controller 112C notifies, with an e-mail, the change of the authority to a system administrator of an organization for which the authority has been changed. For example, when authority of each of the organization B and the organization D is invalidated, the controller 112C transmits the e-mail to a person in charge of a system of each of the organization B and the organization D. The processing device 110 operating according to the program PRC is the same as the processing device 110 in the first embodiment in that the processing device 110 executes the authority management method explained above but is different from the processing device 110 in the first embodiment in that the processing device 110 functions as the controller 112C in the change processing SA110 and the notification processing SA120.

According to the present embodiment as well, when the system administrator in the organization A restores authority once invalidated, it is unnecessary to check content of a contract and a work load of the person in charge of the system is reduced. According to the present embodiment, authority of the slave group can be changed in association with a change of authority set in the master group.

### 3. MODIFICATIONS

The embodiments explained above can be modified as explained below.

(1) The management unit 111 and the controller 112A in the first embodiment are the software modules. However, one or both of the management unit 111 and the controller 112A may be a hardware module such as an ASIC (Application Specific Integrated Circuit). Even if at least one of the management unit 111 and the controller 112A is a hardware module the same effects as the effects of the first embodiment are achieved. Similarly, the controller 112B in the second embodiment may be a hardware module or the controller 112C in the third embodiment may be a hardware module.

(2) The program PRA may be manufactured alone and may be provided for a fee or free of charge. Specific aspects in providing the program PRA include an aspect in which the program PRA is written in a computer-readable recording medium such as a flash ROM and provided and an aspect in which the program PRA is provided by being downloaded through an electric communication line such as the Internet. By causing a general computer to operate according to the program PRA provided by these aspects, it is possible to cause the computer to execute a display method of the present disclosure. Similarly, the program PRB may be manufactured or provided alone or the program PRC may be manufactured or provided alone.

(3) The management target equipment in the embodiments explained above is the projector. However, the management target equipment for which authority is changed according to the present disclosure is not limited to the projector and may be a digital signage, an electronic blackboard, a personal computer, a printer, or a scanner.

### 4. SUMMARY OF THE PRESENT DISCLOSURE

The present disclosure is not limited to the embodiments and the modifications explained above and can be implemented in various aspects in a range not departing from the spirit of the present disclosure. For example, the present disclosure can also be implemented according to the following aspects. The technical features in the embodiments explained above corresponding to technical features in the aspects described below can be replaced or combined as appropriate in order to solve a part or all of the problems of the present disclosure or in order to achieve a part or all 1 of the effects of the present disclosure. The technical features can be deleted as appropriate unless the technical features are explained as essential technical features in the present specification.

A summary of the present disclosure is appended below.

### Appendix 1

An authority management device according to an aspect of the present disclosure includes: a management unit; and a controller. The management unit manages, in linkage with first identification information for identifying a first group to which a user who can access management target equipment, which is a management target of authority, belongs, first authority information representing one or a plurality of kinds of authority initially set for the first group and representing authority invalidated after the initial setting, and the controller executes: acquiring a change request for the first authority information; and changing the first authority information in response to the change request. According to this aspect, it is possible to change authority set for the management target equipment for each group while reducing a load imposed on a person in charge of a system who manages the authority.

### Appendix 2

An authority management device according to a more preferable aspect is the authority management device described in the appendix 1, in which the first authority information includes s flag information indicating whether the initially set authority is valid or invalid. According to this aspect, it is possible to collectively invalidate or restore the authority set for the management target equipment for each group.

### Appendix 3

An authority management device according to another preferable aspect is the authority management device described in the appendix 1 or the appendix 2, in which the controller further executes notifying that the first authority information was changed. According to this aspect, a group for which authority has been changed can grasp the change of the authority.

### Appendix 4

The authority management device according to still another preferable aspect is the authority management device described in any one of the appendixes 1 to 3, in which the management unit manages, in linkage with second identification information for identifying a second group that is a slave group of the first group, second authority information representing one or a plurality of kinds of authority for the management target equipment initially set for the second group and indicating authority invalidated after the initial setting and manages the first identification information and the second identification information in linkage with each other, and the controller further executes changing the second authority information according to a change of the first authority information. According to this aspect, it is possible to change authority of the slave group in linkage with a change of authority of a master group.

### Appendix 5

An authority management device according to yet still another preferable aspect is the authority management device described in the appendix 4, in which the controller further executes notifying that the second authority information was changed. According to this aspect, the slave group for which authority is changed in association with the change of the authority of the master group can grasp the change of the authority.

### Appendix 6

An authority management device according to yet still another preferable aspect is the authority management device described in any one of the appendixes 1 to 5, in which the first authority information includes validity information indicating valid authority among the initially set one or plurality of kinds of authority and invalidity information indicating invalid authority among the initially set one or plurality of kinds of authority, and the changing the first authority information in response to the change request is changing the validity information and the invalidity information in response to the change request. According to this aspect, it is possible to individually change, for each kind of authority, initially set one or a plurality of kinds of authority.

### Appendix 7

An authority management device according to yet still another preferable aspect is the authority management device described in the appendix 6, in which the changing the validity information in response to the change request is deleting, from the validity information, information indicating authority instructed by the change request to be invalidated. According to this aspect, it is possible to individually change, for each kind of authority, initially set one or a plurality of kinds of authority.

What is claimed is:

1. An authority management device comprising:
a management unit; and
a controller, wherein
the management unit manages, in linkage with first identification information for identifying a first group to which a user who can access management target equipment, which is a management target of authority, belongs, first authority information representing one or a plurality of kinds of authority initially set for the first group and representing authority invalidated after the initial setting, and
the controller executes:
acquiring a change request for the first authority information; and
changing the first authority information in response to the change request.

2. The authority management device according to claim 1, wherein the first authority information includes flag information indicating whether the initially set authority is valid or invalid.

3. The authority management device according to claim 2, wherein the controller further executes notifying that the first authority information was changed.

4. The authority management device according to claim 2, wherein
the management unit manages, in linkage with second identification information for identifying a second group that is a slave group of the first group, second authority information representing one or a plurality of kinds of authority for the management target equipment initially set for the second group and indicating authority invalidated after the initial setting and manages the first identification information and the second identification information in linkage with each other, and
the controller further executes changing the second authority information according to a change of the first authority information.

5. The authority management device according to claim 4, wherein the controller further executes notifying that the second authority information was changed.

6. The authority management device according to claim 1, wherein
the first authority information includes validity information indicating valid authority among the initially set one or plurality of kinds of authority and invalidity information indicating invalid authority among the initially set one or plurality of kinds of authority, and
the changing the first authority information in response to the change request is changing the validity information and the invalidity information in response to the change request.

7. The authority management device according to claim 6, wherein the changing the validity information in response to the change request is deleting, from the validity information, information indicating authority instructed by the change request to be invalidated.
